(19) United States
(12) Patent Application Publication
(10) Pub. No.: US 2026/0031690 A1
(43) Pub. Date: Jan. 29, 2026

(54) METHOD AND APPARATUS FOR MANUFACTURING OF A GENERATOR

(71) Applicant: NextPower360 Co., Leicester, NC (US)

(72) Inventor: Benedetto Anthony IACOVELLI, Leicester, NC (US)

(21) Appl. No.: 19/277,921

(22) Filed: Jul. 23, 2025

Related U.S. Application Data
(60) Provisional application No. 63/675,009, filed on Jul. 24, 2024.

(51) Int. Cl. H02K 15/121; H02K 1/20; H02K 15/0273; H02K 15/33

(52) U.S. Cl. CPC H02K 15/121; H02K 1/20; H02K 15/0273; H02K 15/33; H02K 2215/00

(57) ABSTRACT

A method for forming a dynamoelectric machine including providing a jig, arranging an inner yoke and an outer yoke on the jig, providing concentrically arranged rotor layers between the inner yoke and the outer yoke, filling spaces between adjacent ones of the concentrically arranged rotor layers with a powder which will define stator layers, pressing the powder within the spaces between the adjacent ones of the concentrically arranged rotor layers, and heating, sintering, and/or curing the pressed powder to form the stator layers between the adjacent ones of the concentrically arranged rotor layers.

### CROSS-REFERENCE TO RELATED APPLICATIONS

The present application claims priority to U.S. Patent Application No. 63/675,009, filed on Jul. 24, 2024, the entire contents of which are hereby incorporated herein by reference.

### BACKGROUND OF THE INVENTION

### 1. Field of the Invention

The present invention relates to novel methods, structures, and systems for improving generators and motors. More specifically, the present invention relates to inexpensive and short supply chain manufacture of dynamoelectric machines. Example embodiments of methods of the present invention include in situ compaction bonding, 3D printing, and wound layers. Example embodiments of the present invention can be combined.

### 2. Description of the Related Art

Motors and generators are formed from materials and components in a complex series of manufacturing steps that, for many types of magnets, may involve supply chains made by many companies on several continents. For example, the silicon steel that makes up the cores of conventional electrical machines commonly starts with ores mined in Brazil and Australia. In China, the iron is smelted into silicon steel that is then rolled many times to make it into thin sheet metal. The sheet metal rolls may be shipped to India, South Korea, the U.S., Germany or Vietnam, etc., where structures with specific shapes are stamped out from the sheet metal. These structures are coated, stacked, and heat treated. Then they need to be paired with electromagnets or permanent magnets.

Electromagnet coils of coated wire or hair pin material are wound and integrated into them with some sort of extra insulative boundary. Final assembly may take place in the U.S. The latter has been increased by the recent American ‘reshoring’ initiative.

Permanent magnets are usually made in their own, separate, specialty company via a series of parallel processes that also may involve long supply chains stretching over several continents.

Nearly every type of magnet is made by combining and heating base ingredients, grinding the resulting alloy or compound to a very fine powder, forming or compacting the powder into a desired solid unmagnetized shape, perhaps a machining step, then magnetizing the solid shape in a desired direction. Magnets can be broken down into categories by base materials and also by how the powder is formed into a solid shape. The different material types of magnets such as Ferrite, Alnico, Neodymium, etc. can be made in various forms such as sintered, bonded, flexible, etc.

### SUMMARY OF THE INVENTION

To overcome the problems described above, example embodiments of the present invention provide alternative and new ways of manufacturing a novel generators or motors that each allow most, if not all, of the manufacturing to occur under one roof, possibly at a single station.

According to an example embodiment of the present invention, a method for forming a dynamoelectric machine includes providing a jig, arranging an inner yoke and an outer yoke on the jig, providing concentrically arranged rotor layers between the inner yoke and the outer yoke, filling spaces between adjacent ones of the concentrically arranged rotor layers with a powder which will define stator layers, pressing the powder within the spaces between the adjacent ones of the concentrically arranged rotor layers, and heating, sintering, and/or curing the pressed powder to form the stator layers between the adjacent ones of the concentrically arranged rotor layers.

According to another example embodiment of the present invention, a method for forming a dynamoelectric machine includes providing an inner yoke, alternatingly providing concentric stator layers and rotor layers on an outer surface of the inner yoke, and providing an outer yoke radially outward of an outer surface of a series of the concentric stator layers and rotor layers. The stator layers and the rotor layers are adhered to one another.

The above and other features, elements, characteristics, steps, and advantages of the present invention will become more apparent from the following detailed description of example embodiments of the present invention with reference to the attached drawings.

### BRIEF DESCRIPTION OF THE DRAWINGS

FIG. 1 shows a perspective view of a bottom plate of a representative jig according to an example embodiment of the present invention.

FIG. 2 shows a perspective view of the bottom plate of FIG. 1 with inner and outer flux return yokes provided in inner and outer grooves of the bottom plate.

FIG. 3 shows a perspective view of the assembly of FIG. 2 with rotor layers added between the inner and outer flux return yokes.

FIG. 4 shows a perspective view of the assembly of FIG. 3 with inner and outer pressure supports added.

FIG. 5 shows a perspective view of the assembly of FIG. 4 with voids between the rotor layers having been filled with magnet powder and binder.

FIG. 6 shows a perspective view of a tamper used with the assembly of FIG. 5.

FIG. 7 shows a perspective view of the assembly of FIG. 5 after being compressed by the tamper.

FIG. 8 shows an exploded view of the assembly of FIG. 3 with the tamper and inner pressure support included.

FIG. 9a shows a cutaway view of another example embodiment of a manufacturing assembly of the present invention.

FIG. 9b shows a perspective view of the assembly of FIG. 9a.

FIG. 10 shows a perspective view of a monolithic multi rotor body generator according to an example embodiment of the present invention.

FIG. 11 shows a side view of a portion of a multi rotor body generator according to an example embodiment of the present invention.

FIG. 12 shows a perspective view of a monolithic multi rotor body generator including wires connected to the rotor in accordance with an example embodiment of the present invention.

FIG. 13 shows a perspective view of a 3D printing manufacturing arrangement of a monolithic multi rotor body generator in accordance with an example embodiment of the present invention.

FIGS. 14a and 14b show examples of a multi rotor body generator made in multiple sections in accordance with another example embodiment of the present invention.

FIG. 15 shows a perspective view of a wrapping/spooling manufacturing arrangement of a monolithic multi rotor body generator in accordance with an example embodiment of the present invention.

### DETAILED DESCRIPTION OF EXAMPLE EMBODIMENTS

Example embodiments of the present invention will now be described with reference to the Drawings.

Example embodiments of the present invention are usable for dynamoelectric machines including electric motor applications as well as generator applications (e.g., the example embodiments of the present invention are applicable for any type of dynamoelectric machine). For the purpose of this disclosure, the focus will be on drum type example embodiments of homopolar type generators and motors, but the principles and techniques according to example embodiments disclosed herein apply to all homopolar/designs in ways that are clear to those skilled in the art.

As discussed briefly above, nearly every type of magnet is made by combining and heating base ingredients, grinding the resulting alloy or compound to a very fine powder, forming or compacting the powder into a desired solid unmagnetized shape, perhaps a machining step, then magnetizing the solid shape in the desired direction. Magnets can be broken down into categories by base materials and also by how the powder is formed into a solid shape. The different material types of magnets such as Ferrite, Alnico, Neodymium, etc. can be made in various forms such as sintered, bonded, flexible, etc.

This applies to common types of magnets described below.

Ferrite magnets are most commonly made by heating a mixture of iron oxide (Fe2O3) and strontium carbonate (SrcO3) or barium carbonate (BaCO3) to between 1000 to 1350 degrees C. (Calcinating) forming a metallic oxide. That metal oxide is ground to a very fine powder. Stronger ferrite magnets may have a strength (BHMax) of 5 MGOe.

Alnico Magnets can have various compositions. A representative example mixture is Alnico 8, which may contain 31.5% Iron, 36% Cobalt, 13.5% Nickel, 7.2% Aluminum, 3.5% Copper, 7.5% Titanium and 0.8% Niobium, for example. Alnico Magnets can be made from either sintering or casting processes. In casting, the components are melted together at 1750-1780 deg C. The molten Alnico alloy is poured into molds and rapidly cooled. If a sintered or other form of an Alnico magnet is desired, the mix of metal powders is used or the alloy is ground to a powder. Stronger Alnico magnets may have a BHMax of 10 MGOe.

Samarium cobalt magnets are made with samarium and cobalt and can be doped with varying small amounts of iron, copper, hafnium, zirconium and praseodymium. As above, these components are melted together, the alloy is cooled and ground to a very fine powder. They might have a BHMax of 30.

Neodymium magnets include Iron and Boron melted/alloyed in a vacuum induction furnace. Cobalt, Copper, Gadolinium and Dysprosium may be added. Like other magnets, this alloy is cooled and ground to a fine powder. Strong neodymium magnets can have a BHMax of 55 MGOe.

Iron Nitride magnets are made from Fe and N with a ferromagnetic Fe16N2 phase, which has a remarkably high saturation magnetization. These magnets are particularly notable for their independence from rare-earth materials, such as neodymium or dysprosium.

Common to all these types of magnets are that their component materials are usually heated together and then ground to a very fine powder. An interim manufacturing step may include exposing still somewhat mobile powder in the mold to a magnetic field to line up the particles to make an anisotropic magnet that will be stronger and longer lasting.

There are various options on how to get the combined, heated and finely ground powder to a solid formed shape. With sintering, the powder is pressed into a mold and compacted under heat and pressure until the powder fuses. Sintering makes the magnet have its strongest form. A Neodymium sintered magnet might have a BHMax of 55 MGOe.

With rigid Bonding, the magnet powders are mixed with a polymer such as thermoplastic, polyester, nylon, PPS, thermoset epoxies, or Teflon. The amount of binder may be just 3% by volume. Compaction molding and the like can form the mixture into its shape. These processes usually involve a heat and pressure, especially for the low binder volume percent variants to get the binder to spread thinly and have the magnet materials fairly densely packed. They may be compacted under pressures of 6 tons/cm2 and heated. One major advantage of compression bonding is that the magnetic loading can exceed 95% by volume, resulting in higher flux densities than calendered, injection molded, and extruded magnets. Rigid bonded magnets are generally weaker than their sintered variants and stronger than their flexible variants. A rigid bonded neodymium magnet might have a BHMax of 10MGOe.

With flexible forming, usually elastic vinyl or Nitrile are used as a binder. The binders are used in a higher volume percent than in rigid bonding-such as 30%. The magnets can be formed by using rolling, molding, calendaring or extrusion methods. Flexible form magnets are usually their weakest form. A flexible neodymium magnet may have a BHMax of 2-5 MGOe or less.

Whichever forming process is used, the formed magnet structure is not magnetic until it is flashed with a strong magnetizing field in the appropriate orientation.

To make a permanent magnet motor or generator, usually the magnets are affixed to a rotor or stator core. Those standard cores are usually composed of hundreds to tens of thousands of thin laminated, stamped out silicon steel wafers. The silicon steel wafers compose about 50% to 70% of the mass and volume of the machine. Usually there are electromagnet windings in the stator and/or rotor core. By the time the machine is assembled, its parts count is very high and there are so many manufacturing steps needed that its creation could involve, for example, as many as 20 of more different companies/suppliers on several different continents.

Example embodiments of the present invention described in the present disclosure provide an alternative and new ways of manufacturing novel generators or motors that allow most, if not all, of the manufacturing to occur under one roof, possibly at a single station. Below, a concentric drum homopolar generator will be used to demonstrate features and benefits of example embodiments of the present invention, but those skilled in the art can apply the same principles being patented here to other forms of dynamoelectric machines, especially homopolar generators.

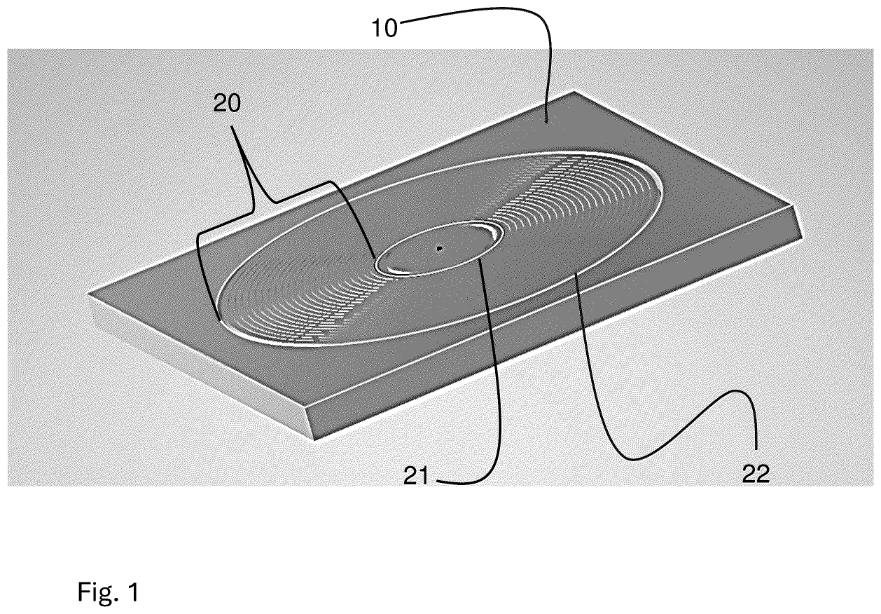

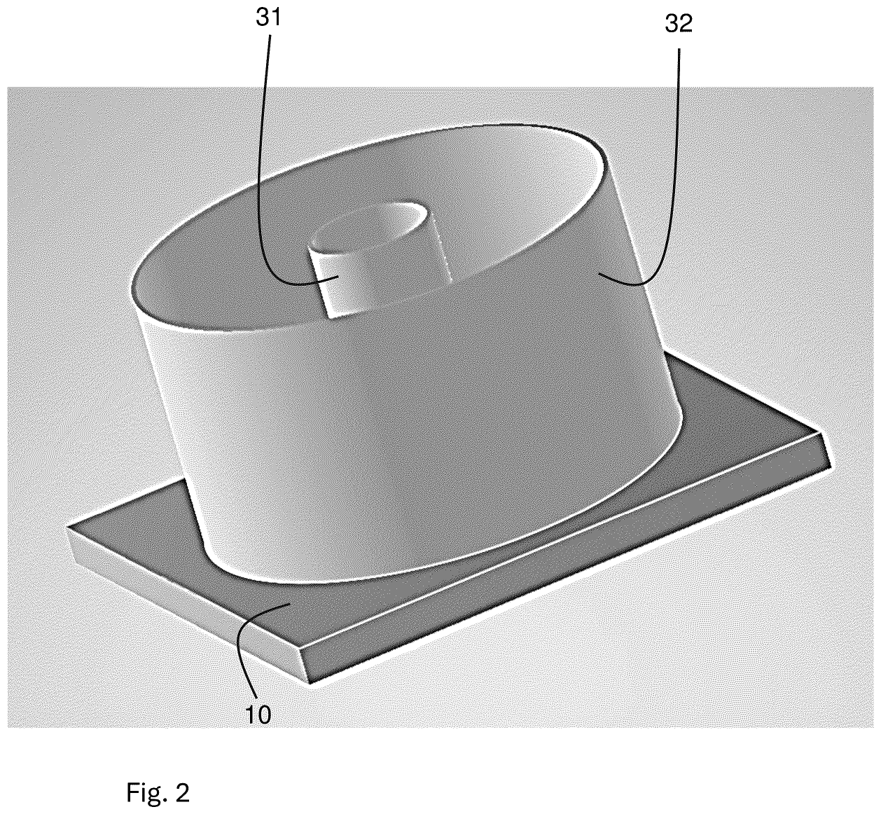

FIG. 1 shows a perspective view of a bottom plate 10 of a representative jig according to an example embodiment of the present invention. The bottom plate 10 preferably includes a series of different diameter concentric circular grooved recesses 20 defined in its upper surface. A radially innermost groove 21 and a radially outermost groove 22 may be deeper and wider than the other circular grooves to accept and position inner and outer yokes 31 and 32, as shown in FIG. 2. Once the inner and outer yokes 31 and 32 have been inserted into the radially innermost groove 21 and a radially outermost groove 22 of the bottom plate 10, an annealing step may be performed using heating elements. The heating elements could, for example, be located within support structures of the jig.

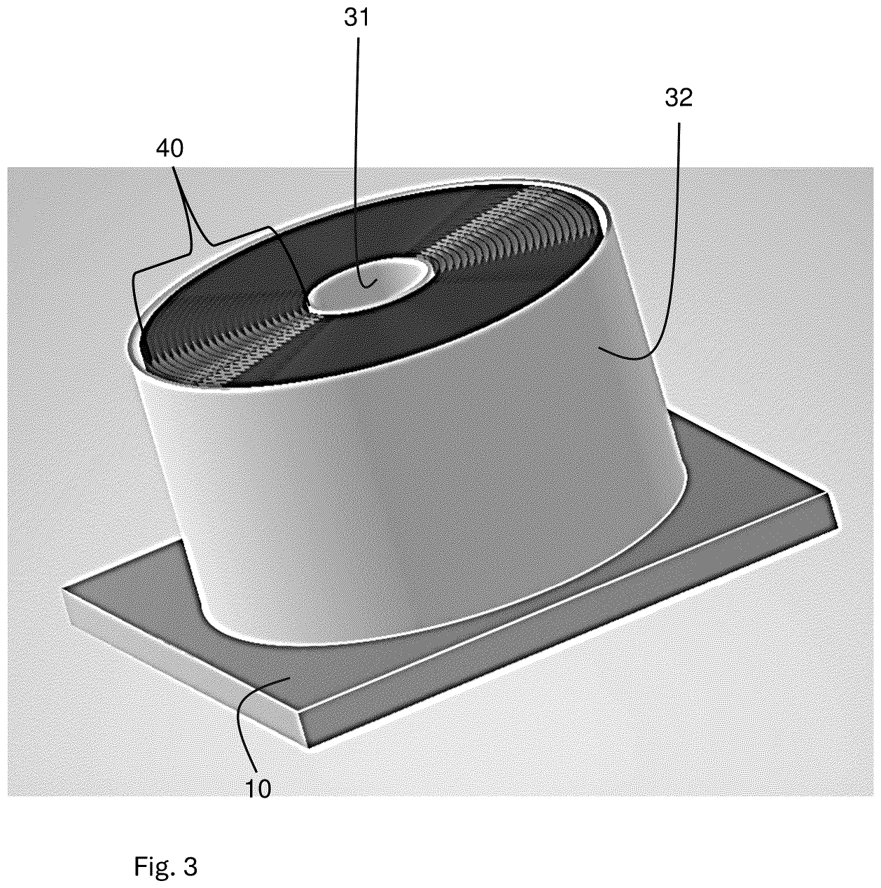

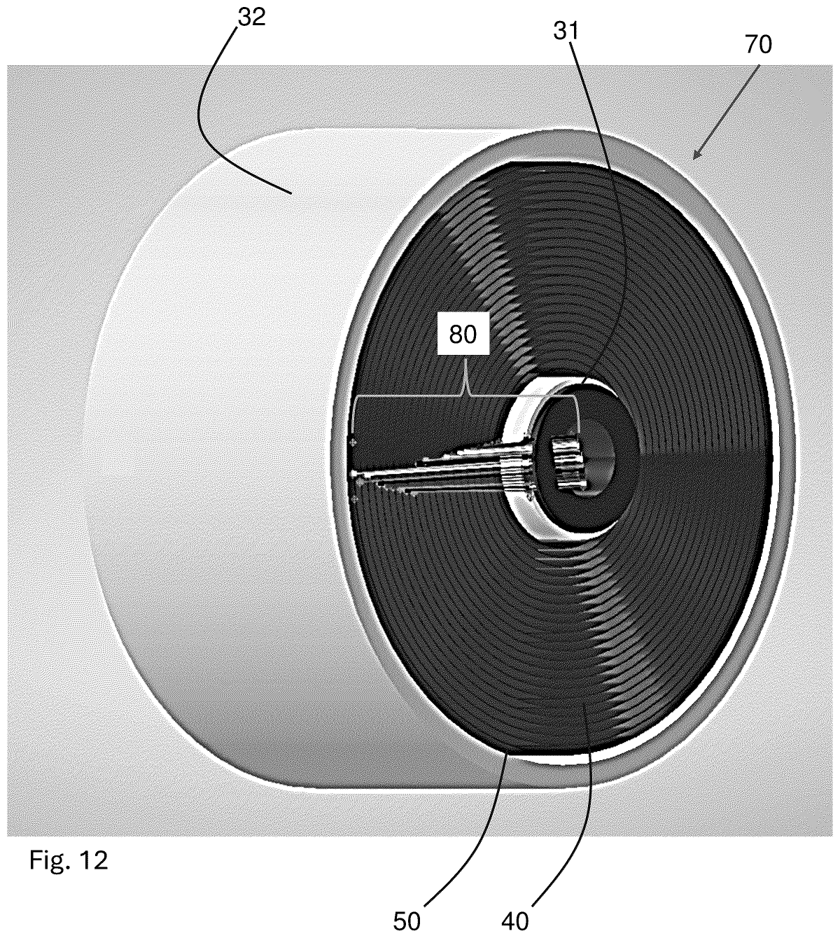

Next, as shown in FIG. 3, rotor layers 40 are added in ones of the concentric circular grooved recesses 20 provided radially between the inner and outer yokes 31 and 32. The rotor layers 40 are preferably made of, for example, copper, silver, iron, or any other electrically conductive material, and especially combinations of materials described in related applications. The rotor layers 40 are preferably a little shorter axially than the flux return layers of the inner and outer yokes 31 and 32 and the grooves 20 housing the rotor layers 40 are preferably not as deep as the radially innermost groove 21 and a radially outermost groove 22 of the bottom plate 10, so the rotor layers 40 are suspended axially with the inner and outer yokes 31 and 32 overlapping the rotor layers 40 on both opposed axial ends. The rotors 40 could have integral tabs for electrical connections to conductors 41 (shown in FIG. 12, for example). In motor applications especially, the rotor layers 40 can be made of layers of parallel or substantially parallel wires or bars that are laterally electrically isolated, similar to computer cables, and formed into cylinders as described in related applications.

The rotor layers 40 and their accepting grooves 20 can have non-uniform spacing such as having progressively wider channels towards the center to accept a greater thickness of magnet powder. The progressive widening of the areas between the rotors 40 can be in direct ratio to the decreasing circumference so that the space/volume between the rotor layers 40 always has the same or substantially the same volume. These spaces are filled with the magnet material of the stator layers 50 (described below), so having wider spaces toward the center helps all the layers have the same amount of magnetism. If different grades or mixtures of magnet materials are used, the space width can be tailored to create uniform magnetism.

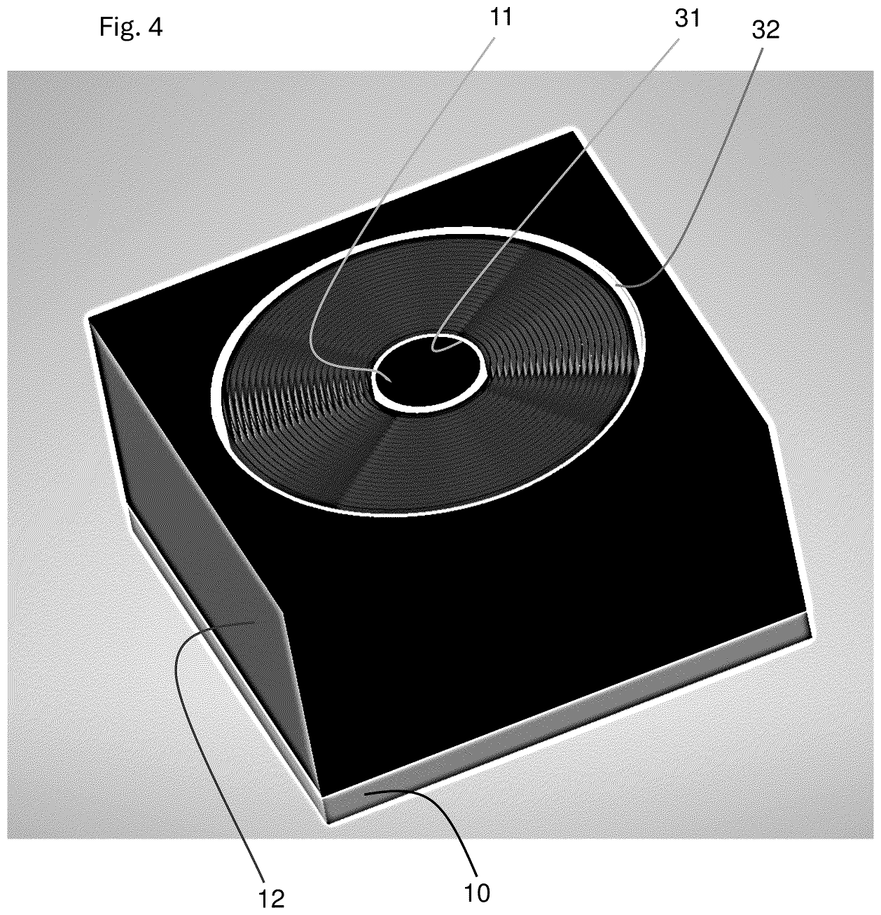

As shown in FIG. 4, outer and inner pressure supports 12 and 11 are respectively provided radially outside of the outer yoke 32 and radially inside of the inner yoke 31. The outer and inner pressure supports 12 and 11 are structured to prevent lateral deformation of the rotor layers 40 and stator layers 50 during compaction. Not shown in FIG. 4 are heating elements (e.g., heating coils) which can be included in the walls of the outer and inner pressure supports 12 and 11.

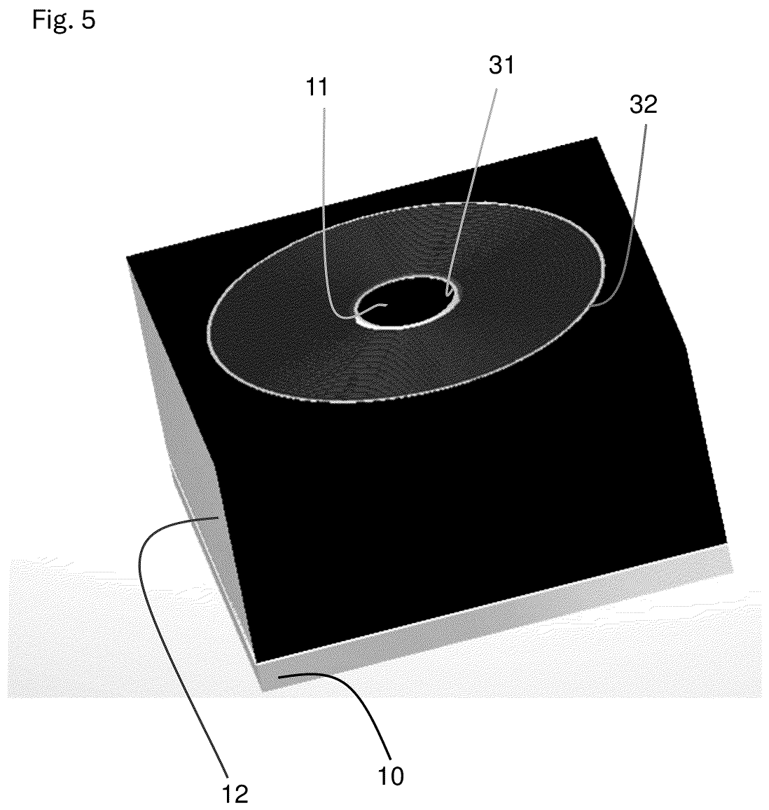

In FIG. 5, voids which are present between radially opposed ones of the rotor layers 40 are filled with magnet powder and binder which will be used to form the stator layers 50. Specifically, the voids are preferably filled with a well tamped well mixed combination of magnet powder with a small volume percent (e.g., about 3-5%) of a well-mixed binder in powder form.

Usable binders include:
Epoxy resins, which have good adhesion to magnetic powders, and resistance to temperature and moisture.
Nylon binders, which can provide flexibility and toughness to the magnet, making them suitable for applications where durability and impact/vibration resistance are important.
Various thermoplastics such as polyethylene, polypropylene, and acrylonitrile butadiene styrene.
Phenolic Resins, which have good thermal stability and mechanical strength.
Some specialty binders or combinations of binders, which may be used depending on specific requirements. Binders can be tailored to enhance magnetic properties, improve processing characteristics, or achieve desired performance in harsh environments.

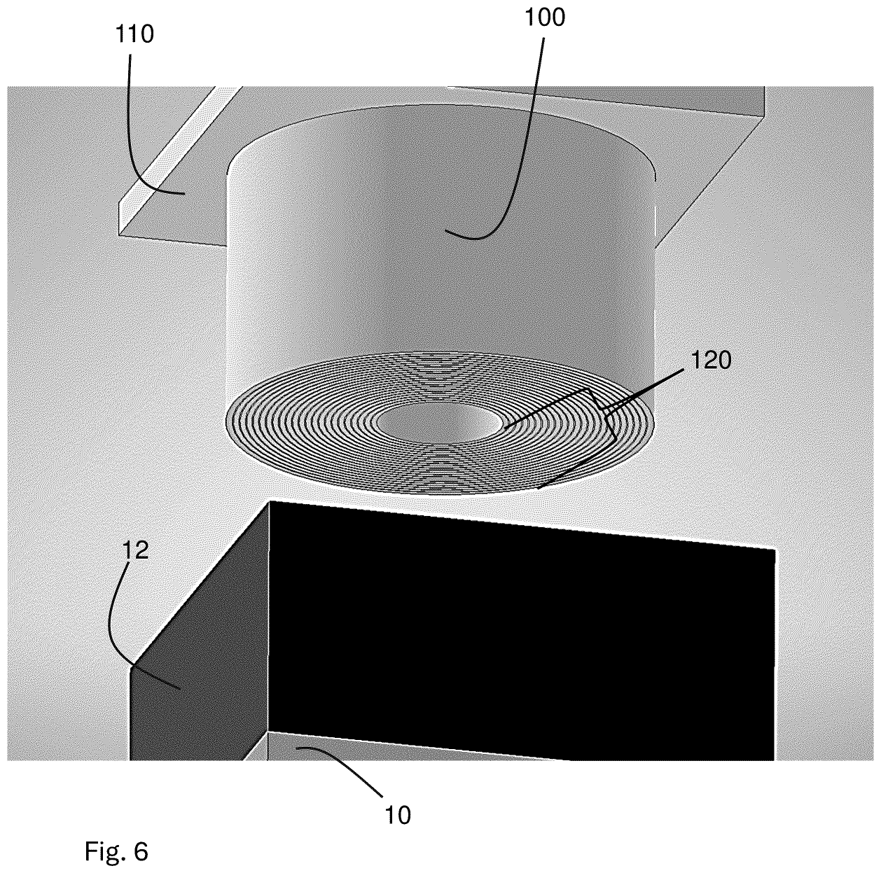

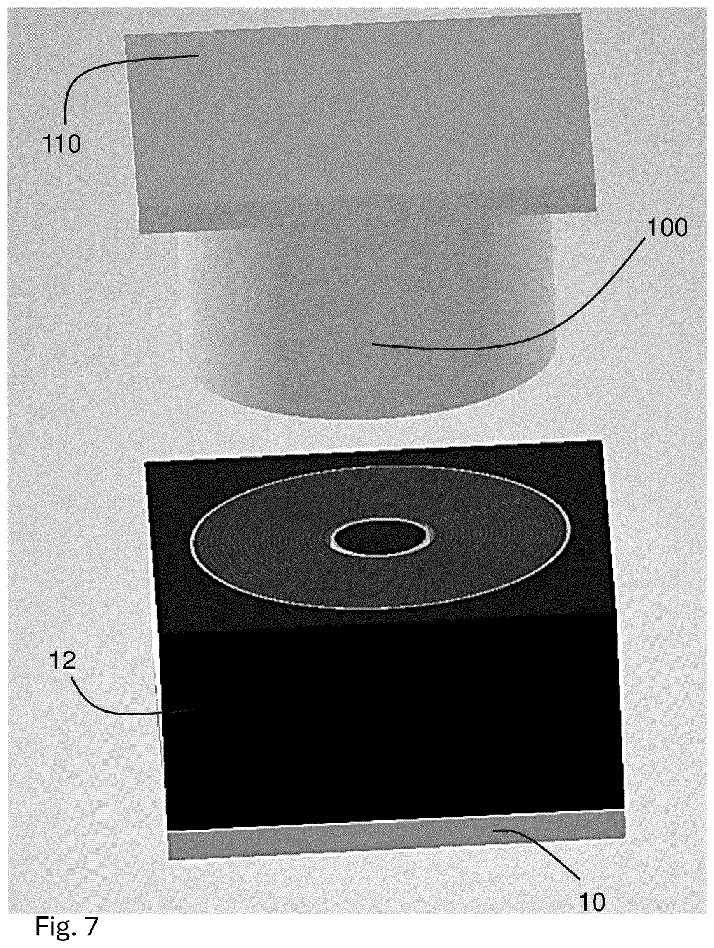

FIGS. 6 and 7 show an example of a tamper 100 which is used to apply pressure to the magnet powder and binder which will be used to form the stator layers 50. The tamper 100 preferably includes an upper base plate 110 and high strength cylindrical protrusions 120 that exactly fit into the powder circular channels between the rotors 40 and rotor/flux returns 31 and 32 to compress the powder which will define the stator layers 50. The tamper 100 can be, for example, driven by a hydraulic, or other type, press. The powder can be compressed, and then the tamper 100 withdrawn so more powder can be added to fill the space left by compaction. This process can be repeated several times.

The tamper 100 is used to compact the powder with pressure sufficient to minimize void space and ensure the powder is as dense and in as much physical contact as possible, usually just short of sintering. Once the channels between opposing ones of the rotor layers 40 are filled completely with the powder, the tamper 100 supplies sufficient pressure, which may be on order of, for example, about 6 tons/cm sq, and the assembly which includes the jig heats the compressed powder mixture. When sintering is not the goal, the temperature is raised sufficiently to melt the binder and achieve a sufficiently low viscosity for it to flow as essentially a thin film bonding the concentrated powder into a solid. If needed, the binder's adhesion to the metals can be augmented with prior roughening the metals' surfaces and/or coatings on the metals' surfaces.

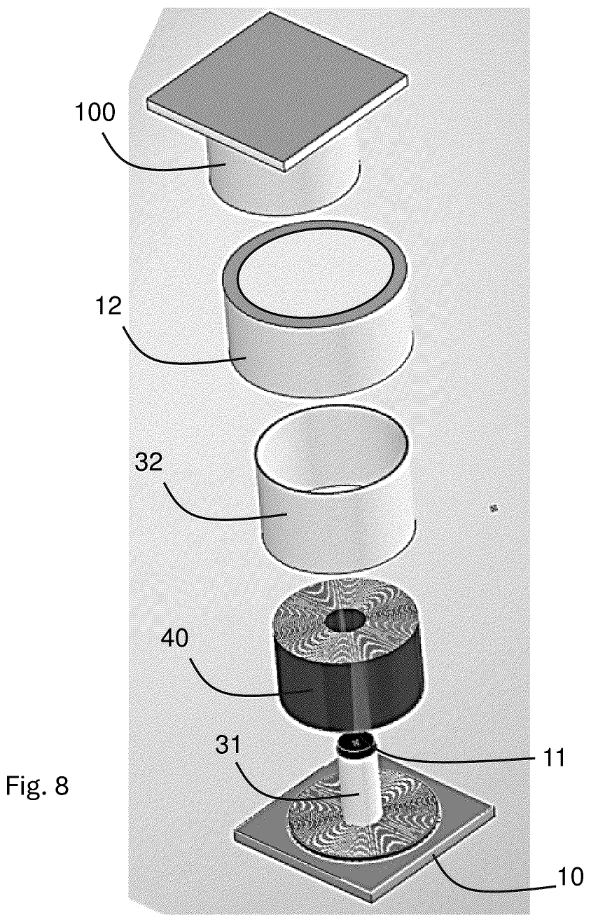

FIG. 8 shows an exploded view of an assembly used in forming a generator according to an example embodiment of the present invention.

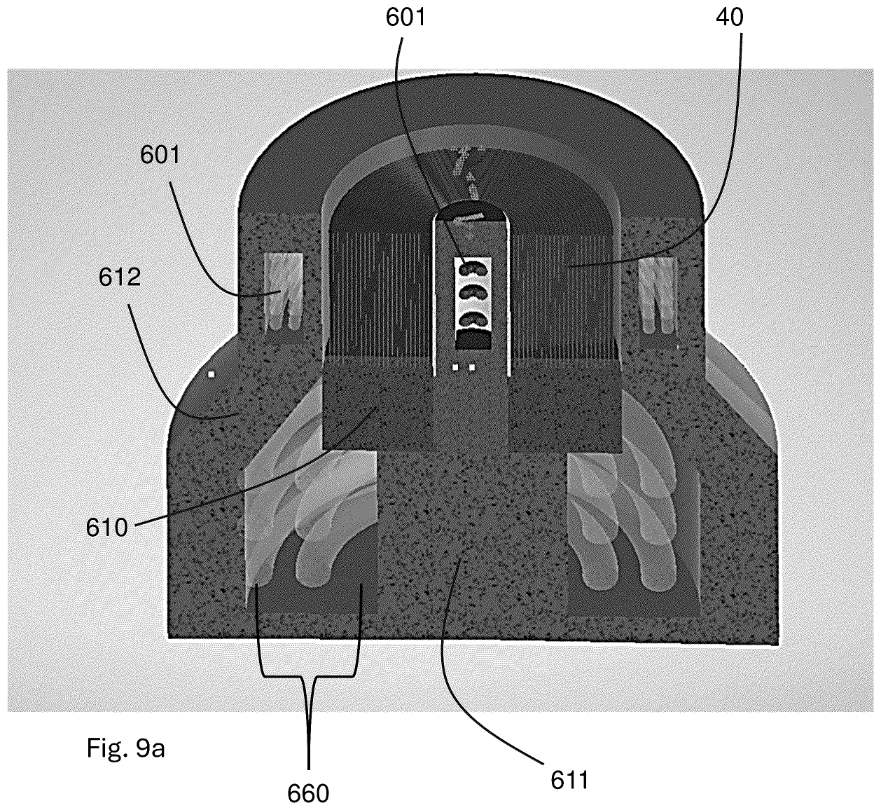

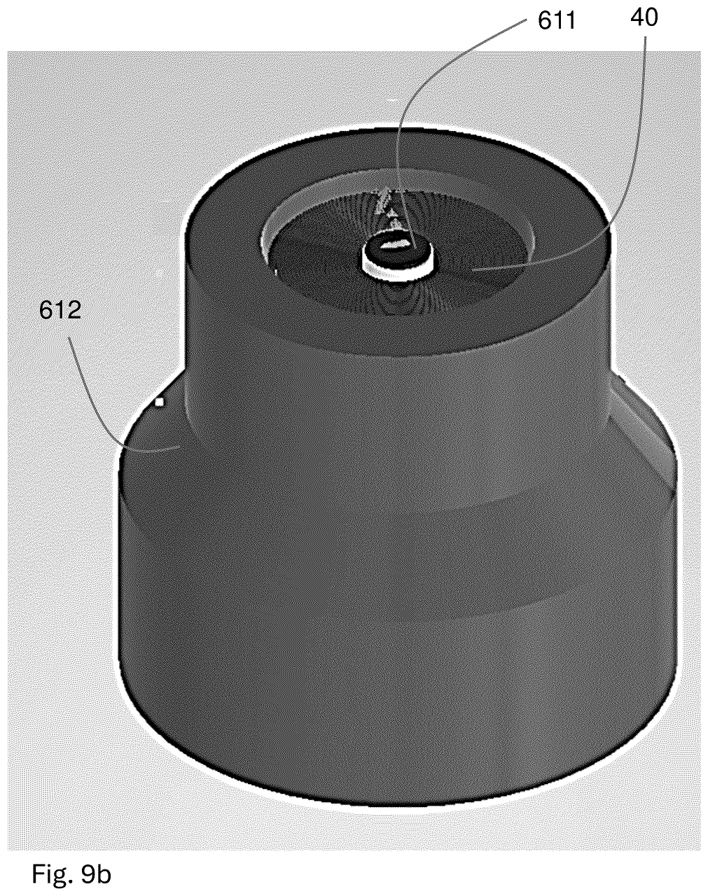

FIG. 9a shows a cutaway view of another example embodiment of a manufacturing assembly of the present invention. Here, the complete apparatus includes upper heater coils 601 in an outer support 612 and an inner support 611 that can raise the temperature of the rotor layers 40 and powder and binder material which will become the stator layer 50 for annealing, melting binder, or sintering. Those inner and outer pressure supports 611 and 612 are shown above in a cylindrical construction rather than the more cubical form shown above in FIGS. 1-7. The outer and inner supports 612 and 611 are also the poles of a large electromagnet coil 660 in the base 610 that can be magnetized partially to create anisotropy with a lower power magnetic field, and then can be magnetized fully with a more powerful magnetic field to magnetize the solid structure of the rotor layers 40 and the powder and binder material which will become the stator layers 50.

In FIG. 9a, the baseplate 610 includes a circular central opening through which a portion of the inner pressure support 611 protrudes, the baseplate 610 being made of a material strong enough to withstand, for example, the hydraulic press and have a low enough magnetic permeability so the flux made in the bottom coil 660 does not short back without going through the rotor layers 40 and the powder and binder material which will become the stator layers 50. Materials such as titanium will work for the baseplate 610. A central pillar of the inner pressure support 611 should be wide enough or angled to support the baseplate 610. It can be supported in many ways to withstand the pressure using alternative structures other than as shown in FIG. 9a. The ways include titanium type support legs, etc.

FIG. 9b shows an external view of the in situ compaction assembly of FIG. 9a. It sits in a hydraulic or non-hydraulic press. A radial magnetic field can be applied, especially starting when the powder is still relatively loose to confer a degree of radial anisotropy. In some example embodiments, the binder density is increased to create greater electrical resistivity of the magnet layers.

There are example embodiments wherein the pressure and temperature is sufficient for sintering of the magnet to occur. In those example embodiments, usually the binder is not used and care is taken with rotor composition and sintering temp and pressure to maintain rotor integrity, conductivity, and prevent/minimize alloy formation.

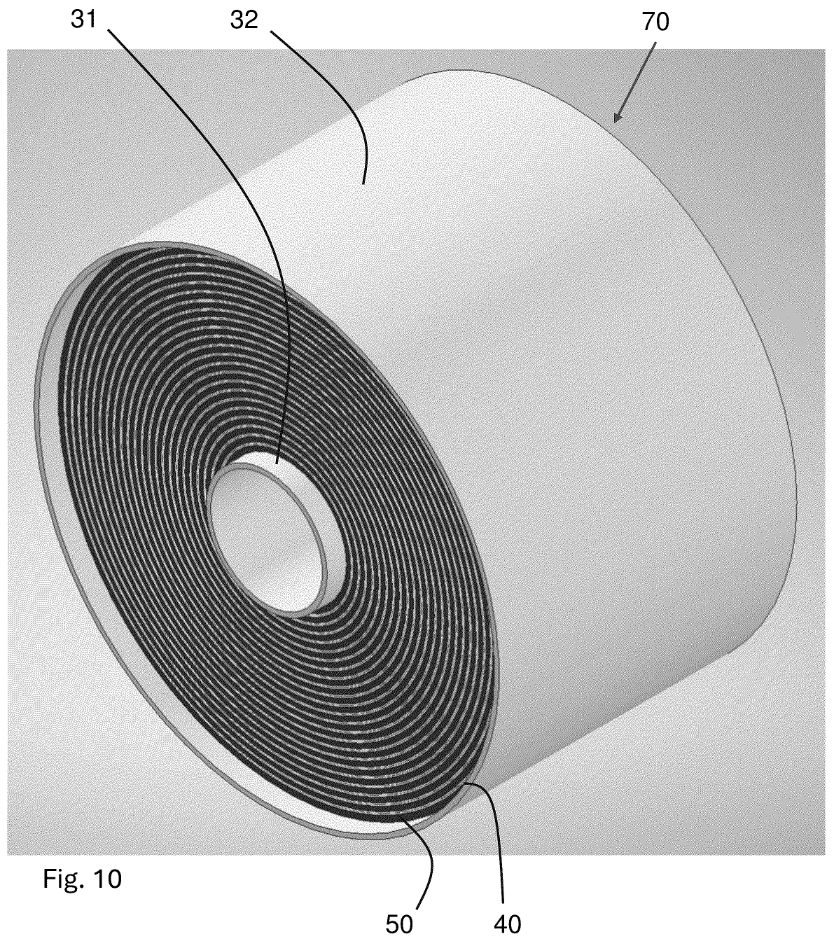

If needed, excess rotor and/or flux return material can be trimmed or ground off. Next, this monolithic assembly 70, as shown in FIG. 10, is magnetized radially. This can be done in a separate magnetizer or with a magnetizer built into the apparatus in which it was made. The magnetizer would have a powerful electromagnet coil in the base and feed one pole up the center post of the central pressure support 11 (as shown in FIG. 4) and the other pole up the external support such that a radial magnetizing field is created. Usually magnets are magnetized with a brief powerful field pulse. In this case the magnetizing field will have to be energized and unenergized more gradually to prevent eddy currents in the metal from altering the radial field morphology and uniformity. It can be removed for its final assembly steps. Following the compaction/heating and magnetization steps, the assembly 70 is now a monolithic, adhered together, single, solid member.

After magnetization, the cylindrical monolithic assembly 70 is removed from the assembly apparatus. When the cylindrical monolithic assembly 70 is spun on its central axis, the magnetic field produced by the stator layers 50 remains a stationary vector force as described by the Faraday Paradox. The rotor layers 40 spin through this stationary paradox radial magnetic field, experiencing the commensurate EMF pushing electrons toward one axial end of the rotor layers 40.

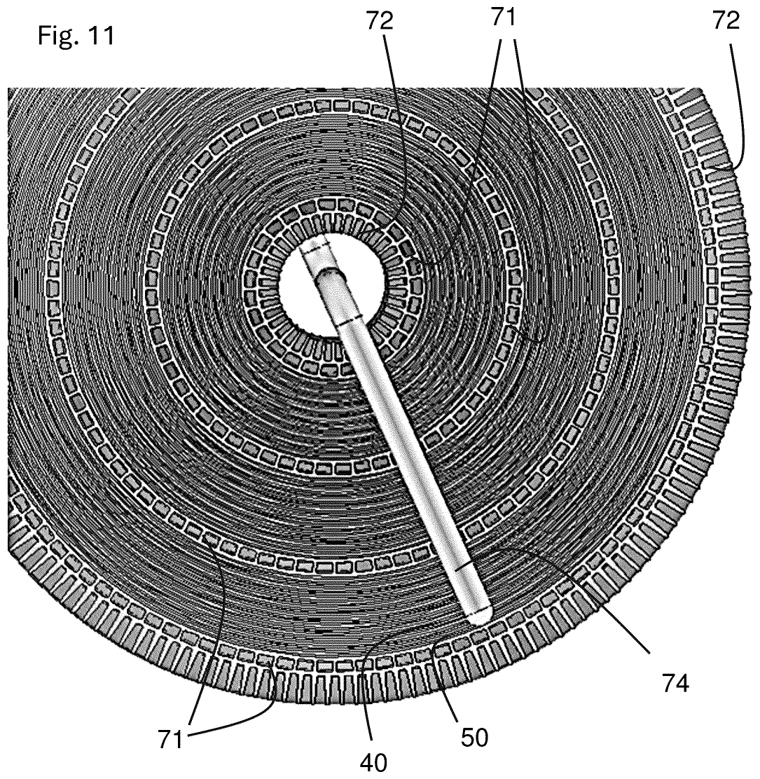

In some units, integral cooling channels will need to be embedded in the rotor/magnet layers 40/50. FIG. 11 shows an example embodiment of the present invention which includes, for example, four cooling channel layers 71 plus internal and external cooling fins 72. A central portion of the dynamoelectric machine includes an actively shielded channel 74 rotor connectors described in a related application.

Cylindrical sleeves which define the cooling channels 71 are made out of a magnetically permeable material and can substitute for one or more rotor layers 40. The structure is preferably suitably crush resistant. Thus, the channels are preferably filled with hard, form fitting rods for support during powder compaction of the stator layers 50. The rods are removed after. If the cooling jacket layer 71 is made of copper or another conductive material/mix, it can additionally function as a portion of the rotor 40.

It is now ready for a rotor wire harness, a flux return rotor wire (connector) shield, a lateral flux return disks, a spacer and an axle. FIG. 12 shows an example embodiment including wires 80 which are provided to connect the rotors layers 40 in series, parallel, or both depending on the desired power output format. In series, the wires connect the axial end of one rotor layer 40 with the opposite axial end of another rotor layer 40 so a series connection is created.

Some assemblies 70 will have walls that would be too thick and have too many layers for efficient magnetization. In that case, multiple thinner walled cylindrical subassemblies can be made with different diameters, magnetized separately and then fit together concentrically. In this case, if desired, the cooling channels can be made to fit between the subassemblies or can be integral to the segments.

In example embodiments where the electrical conductivity enhanced magnets such as those described in U.S. Patent Application No. 63/666,535 are used, the base plate, instead of holding metallic cylindrical rotors, holds cylinders made of a suitably electrically insulative material that can withstand the heat and pressure of the assembly/process. Examples of such materials may be, for example, silicon carbide, alumina, silicon nitride or zirconia, or others-provided they have a sufficiently low brittleness. In these versions the plastic binder is replaced by an electrically conductive material of sufficiently low melting point so as to allow it to liquify at a lower temp than the magnetic material and insulator, so the magnetic material does not significantly alloy or lose its properties and the insulator maintains its integrity. Materials such as silver or a silver copper alloy could function as both the binder and the conductivity enhancement/internal current collecting system. Copper alone could function provided there is sufficient temperature and pressure regulation to keep the copper melted and the magnet material solid.

The above-described in situ powder compaction method is most applicable to thicker magnet/rotor layer and lower rotor number embodiments. The more rotor layers or segments of layers that are connected in series, the higher the voltage, and the thinner the layers, the more fit into a given volume.

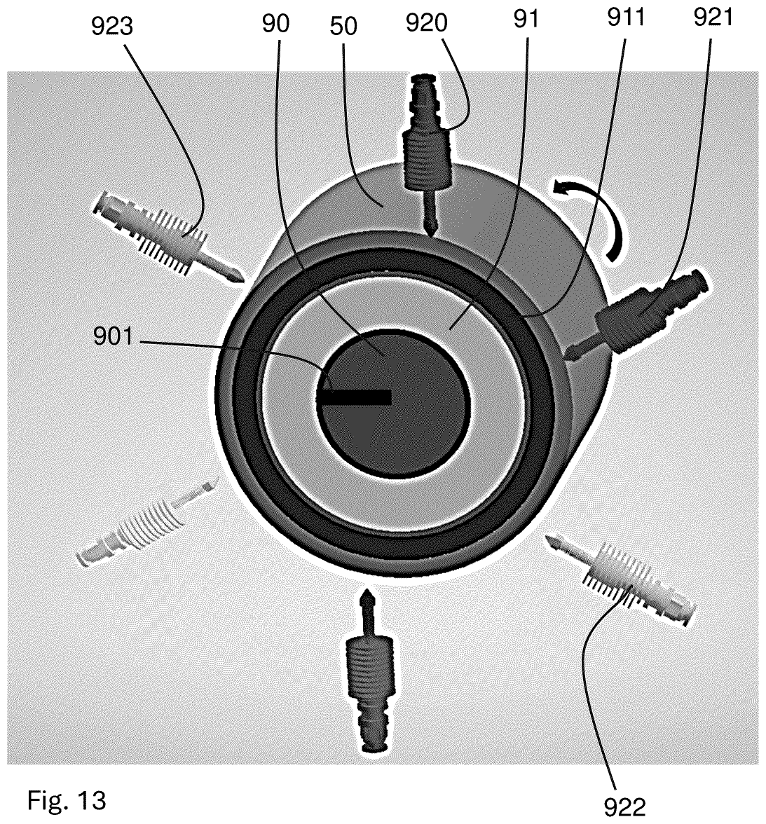

Another example embodiment of the present disclosure provides a different method and apparatus that can make thinner, more numerous layers. FIG. 13 shows an example embodiment of a method and apparatus of example embodiments of the present invention of a sophisticated multi-printhead, 3D printing machine that combines the functions and parts of many 3D printers working together with a single computer control to build the body of the motor/generator in its various layers as the build object rotates between the heads.

The central axle 90 has a wire route notch 901 cut out of it. A spacer 91 holds an inner flux return 911. Two adjacent 3D print heads 920 and 921 are engaged, and lay down a magnet material layer 50. When the layer 50 is thick enough, those heads 920 and 921 disengage and another printhead/heads 922 may lay down an insulating layer. Those insulator heads disengage and the rotor material print heads 923 engage, etc.

There is a portion of the machine that holds a rotatably mounted central core, which can include the axle shaft 90, and possibly the spacer 91 and the inner flux return 911. This central core is rotated, usually in a stepwise fashion, between the device's multiple 3D printer heads 920-923. Each print head is specialized to the material it deposits onto the rotating core. The different print heads function with the printing method (EDM, DED, filament, BPE, etc.) that is best suited for that material and its integration into the electrical machine. Iron nitride lends itself to sputtering deposition with PVD.

At least one printer head 920 and 921 installs magnet material(s) layers (possibly including conduction enhancing material that has longitudinal, electrically continuous architecture laid down by its own print head). Another head or heads 922 may lay down insulator layers between the other layers and possibly between longitudinal rotor segments. Another head/set of heads 923 installs rotor layer 40 materials. The rotor layer 40 may include permeability enhancing inclusions added by their own print head(s) in a prescribed architecture.

The rotor layers 40 can have various adjuvant enhancing materials printed into them with specific architectures by additional print heads. In the conductivity enhanced embodiments, the rotor layers 40 are replaced/supplanted by conductive material deposited within the body of the magnet layer 50 in specific architectures. In motor applications, there is an advantage to laying that material down in discrete generally longitudinal stripes/bars as described in related applications on the topic. The individual bars can be connected in series or parallel depending on the needs of the end use.

The layers are put down in sequence building out a multilayered motor/generator body. The print heads 920-923 engage the greater diameter each time they become activated and withdraw when not in use. The process repeats itself, laying down layer after layer until enough layers are created that the desired voltage/amperage/torque output is achieved once the conductive rotor equivalents are electrically connected with the desired amount in series and in parallel. In motors and some generators, it is advantageous to have the rotor layers laid out as generally parallel, axially longitudinal lines or bars rather than a confluent cylinder.

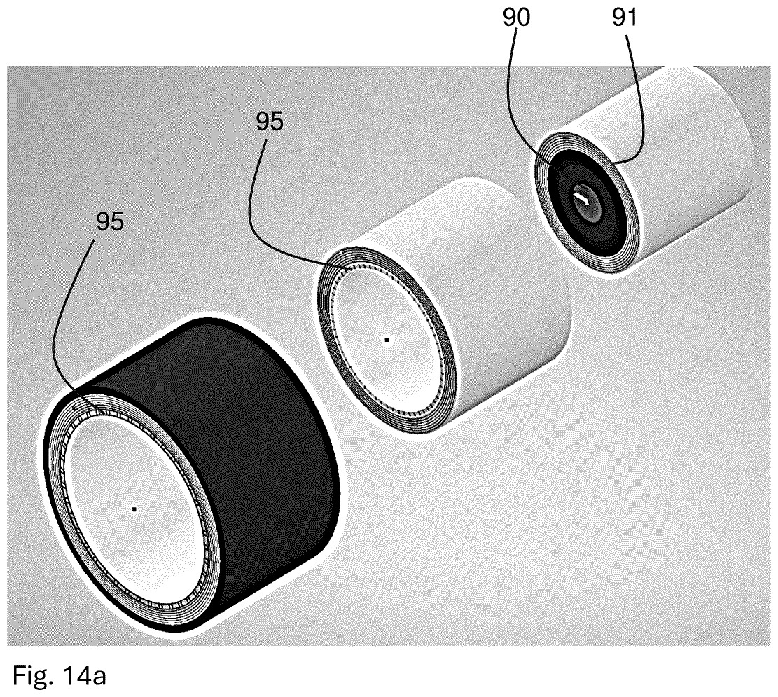

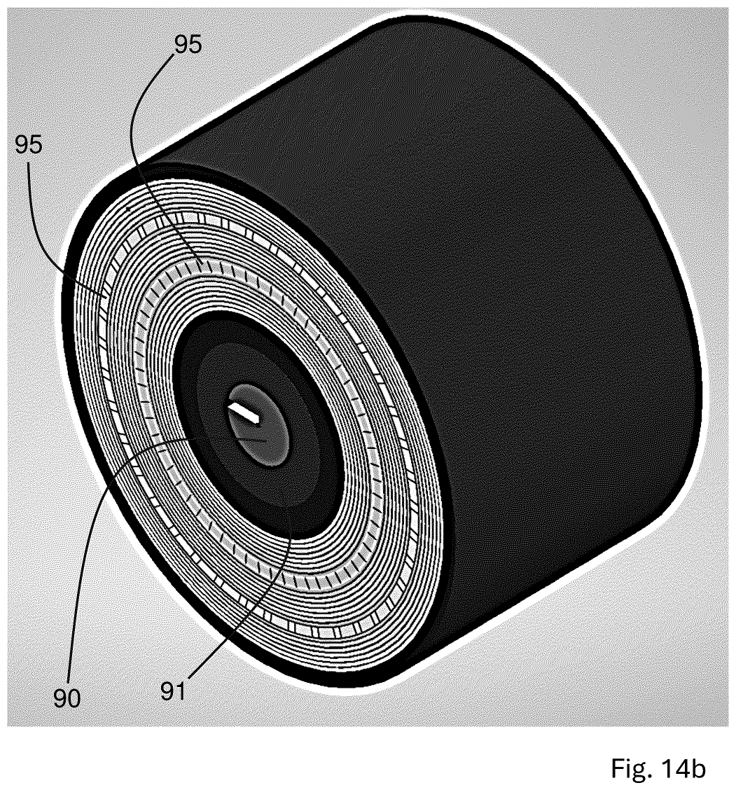

Some example embodiments could be printed from the outside inward. The various material print heads may also deposit their layers onto prebuilt cooling channel sleeves 95 (as shown in FIGS. 14a and 14b), rather than just on the central core 90, or inner/outer flux returns 31 and 32. The cooling sleeves 95 would have suitably different diameters such that when the magnet/rotor/insulator layers 40/50 are built on them to the correct thickness, the assemblies can be concentrically fit together as shown in FIG. 14b.

Alternatively, if desired, the cooling channel layers 95 can be made directly in the body of the machine via 3D printing between the appropriate other layers. Again the cooling layers 95 themselves could be engineered to function as rotors 40 and/or have flux permeability enhancements.

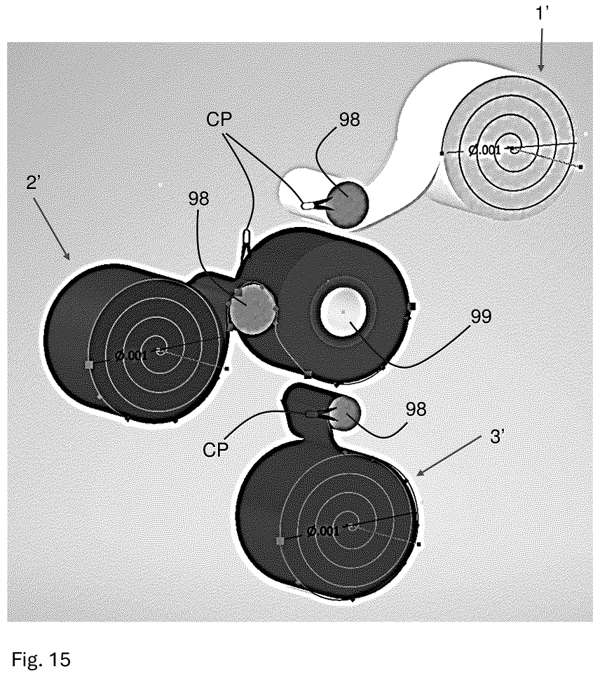

FIG. 15 shows an example embodiment of a method of the present invention in which various layers are rolled together into a functioning homopolar electrical machine. The central core 99 rotates and various layers 1′, 2′, 3′ including stator, rotor, insulating materials are spooled on in turn and cut to size. An adhesive, such as a two-part epoxy coating, for example, is used to adhere the portions of the various layers 1′, 2′, 3′ as thin films on alternating layers deposited as each layer is spooled onto the core 99 to define an electrical machine.

The magnet layers 50 can be conventionally magnetized flexible magnets, for example neodymium/boron/iron alloy fine powder in a 30% nitrile elastomer with north on one surface and south on the other. The magnets can be extruded or calendered through a magnetizer and directly into the rolling apparatus or it can arrive in premade rolls. Another of many options for the magnets would be sheets of Iron nitride.

The rotor layers 40 could be sheet copper, sheet copper segments mounted on a thin membrane and/or copper can be coated, mixed with, or applied to enhancements. The rotor material could be in the form of bars or wires perhaps embedded in a polymer insulation.

The layers may have an adhesive coating including each layer having part A or part B of a two-part curing epoxy coating on it such that the part A and B of the epoxy will cure once rolled onto each other in such a way that the A and A epoxies of respective films 1′, 2′, 3′ touch. Alternatively, or additionally, rollers 98 of the films 1′, 2′, 3′ could be heated to activate the adhesive.

There could be cutting portions CP for each layer that cuts it to the required length. A functional layer may include more than one layer of that material. For example, a total magnet layer may be made up of 2 or more magnet layers. Likewise, a single functioning rotor layer can be made of many layers of rotor material.

Iron nitride could be sputtered on to thin copper or silver, both, or similar metals in sheet or foil in layers to make a conductivity enhanced sheet magnetic material that could be rolled with an insulator. It could be sputtered on metal foil or sheet metal that would function as a magnet-external rotor. The Iron nitride and copper could be layered together with one deposited on the other, this could be rolled into coiled grouped layers, several of which can be separated from a group of similar layers to approximate the conductivity enhanced design. The grouped layers, being insulated from other groups can be connected in series with the other grouped layers.

It should be understood that the foregoing description is only illustrative of example embodiments of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A method for forming a dynamoelectric machine, the method comprising:
providing a jig;
arranging an inner yoke and an outer yoke on the jig;
providing concentrically arranged rotor layers between the inner yoke and the outer yoke;
filling spaces between adjacent ones of the concentrically arranged rotor layers with a powder which will define stator layers;
pressing the powder within the spaces between the adjacent ones of the concentrically arranged rotor layers; and
heating, sintering, and/or curing the pressed powder to form the stator layers between the adjacent ones of the concentrically arranged rotor layers.

2. The method for forming a dynamoelectric machine according to claim 1, wherein
the jig includes a base plate with a plurality of concentric grooves on an upper surface thereof;
the inner yoke and outer yoke are respectively provided in an innermost and outermost one of the plurality of concentric grooves; and
the rotor layers are provided in remaining ones of the plurality of concentric grooves between the innermost and outermost ones of the plurality of concentric grooves.

3. The method for forming a dynamoelectric machine according to claim 2, wherein
the remaining ones of the plurality of concentric grooves are shallower than the innermost and outermost ones of the plurality of concentric grooves.

4. The method for forming a dynamoelectric machine according to claim 1, wherein
the jig includes an inner pressure support positioned radially inward from the inner yoke and an outer pressure support positioned radially outward from the outer yoke.

5. The method for forming a dynamoelectric machine according to claim 4, wherein
at least one of the inner pressure support and the outer pressure support includes a heater to aid in the heating, sintering, and/or curing of the pressed powder to form the stator layers between the adjacent ones of the concentrically arranged rotor layers.

6. The method for forming a dynamoelectric machine according to claim 1, wherein
the pressing of the powder within the spaces between the adjacent ones of the concentrically arranged rotor layers is performed with a tamper including cylindrical protrusions which fit between the spaces between the adjacent ones of the concentrically arranged rotor layers.

7. The method for forming a dynamoelectric machine according to claim 6, wherein
after the pressing of the powder within the spaces between the adjacent ones of the concentrically arranged rotor layers is performed with the tamper, the tamper is raised and more of the powder is added to the spaces between the adjacent ones of the concentrically arranged rotor layers before being pressed again with the tamper until the spaces between the adjacent ones of the concentrically arranged rotor layers are filled with compacted powder.

8. The method for forming a dynamoelectric machine according to claim 1, wherein
the rotor layers have a larger axial height than that of the stator layers.

9. The method for forming a dynamoelectric machine according to claim 1, wherein
the rotor layers are directly adhered to the stator layers.

10. The method for forming a dynamoelectric machine according to claim 1, further comprising:
fastening electrical conductors to axial ends of the rotor layers and electrically connecting the rotor layers in series and/or parallel.

11. The method for forming a dynamoelectric machine according to claim 4, wherein
the inner pressure support and the outer pressure support define poles of an electromagnet usable to magnetize the stator layers after the heating, sintering, and/or curing of the pressed powder.

12. A method for forming a dynamoelectric machine, the method comprising:
providing an inner yoke;
alternatingly providing concentric stator layers and rotor layers on an outer surface of the inner yoke; and
providing an outer yoke radially outward of an outer surface of a series of the concentric stator layers and rotor layers; wherein
the stator layers and the rotor layers are adhered to one another.

13. The method for forming a dynamoelectric machine according to claim 12, wherein
the alternatingly providing of the concentric stator layers and rotor layers on the outer surface of the inner yoke is performed by using multiple 3D printing nozzles to respectively apply the stator layers and the rotor layers while rotating the inner yoke.

14. The method for forming a dynamoelectric machine according to claim 12, wherein
the alternatingly providing of the concentric stator layers and rotor layers on the outer surface of the inner yoke is performed by using multiple spools and rollers to respectively apply the stator layers and the rotor layers while rotating the inner yoke.

15. The method for forming a dynamoelectric machine according to claim 14, wherein
one of the multiple spools includes material used to form the stator layers and a first part of a multi-part epoxy, and another one of the multiple spools includes material used to form the rotor layers and a second part of the multi-part epoxy.

16. The method for forming a dynamoelectric machine according to claim 12, wherein
a cooling channel layer is provided radially outside of the concentric stator layers and rotor layers on the outer surface of the inner yoke.

17. The method for forming a dynamoelectric machine according to claim 12, wherein
at least one of the inner yoke and the outer yoke includes cooling channels and radially extending cooling fins.

18. The method for forming a dynamoelectric machine according to claim 12, further comprising:
providing additional concentric stator layers and rotor layers on a radially outer surface of the outer yoke.
